(19) United States
(12) Patent Application Publication
(10) Pub. No.: US 2025/0368194 A1
(43) Pub. Date: Dec. 4, 2025

(54) METHOD FOR MONITORING A TRAFFIC AREA USING A TRAFFIC MONITORING SYSTEM

(71) Applicant: Continental Automotive Technologies GmbH, Hannover (DE)

(72) Inventor: Ulrich Stählin, Eschborn (DE)

(73) Assignee: Continental Automotive Technologies GmbH, Hannover (DE)

(21) Appl. No.: 19/218,297

(22) Filed: May 25, 2025

(30) Foreign Application Priority Data
May 28, 2024 (DE) 10 2024 204 936.0

(51) Int. Cl. B60W 30/09; G08G 1/01

(52) U.S. Cl. CPC B60W 30/09; G08G 1/012; B60W 2554/40; B60W 2556/45

(57) ABSTRACT

A method for monitoring a traffic area with a traffic monitoring system comprises monitoring a traffic area with a global monitoring system and monitoring at least one partial traffic area of the traffic area with a local monitoring system. The traffic monitoring system establishes a global communication connection to a vehicle located in the traffic area with at least one global communication unit and a local communication connection to the vehicle in the partial traffic area with at least one local communication unit. The global system controls the vehicle by determining a route with the global system; and transmitting control commands via the global communication connection to the vehicle. A control command is transmitted to the vehicle by the local communication unit when the vehicle is in the partial traffic area and the local system detects a hazardous situation.

### TECHNICAL FIELD

The embodiments relate to a method for monitoring a traffic area using a traffic monitoring system.

### BACKGROUND

The degree of automation of individual traffic is steadily increasing in order to gradually increase the comfort of the occupants of a vehicle and the safety of the occupants and other road users. In order to also make parking more convenient, there are systems that take care of the parking of the vehicle for the driver or the vehicle occupants. In this case, the system takes over control of the vehicle from a transfer region and moves it, for example using a large number of sensors connected to the system, to a free destination defined by the system or the driver. On the way to the destination, a variety of obstacles may appear, to which the system must react, for example by reducing the speed of the vehicle or by bringing the vehicle to a complete standstill.

To be able to react quickly to obstacles or other hazardous situations, communication between the vehicle and the system must always be ensured. For example, a permanent communication connection is established and monitored. If the communication connection between the system and the vehicle is interrupted, an emergency stop is initiated for the entire traffic area. This may cause delays in the entire parking system.

### SUMMARY

An objective is to have a method which increases the safety of a traffic monitoring system and reduces delays in the traffic monitoring system due to a termination of the communication connection between the system and the vehicle.

To achieve the object, a method for monitoring a traffic area using a traffic monitoring system is provided. The traffic monitoring system comprises a global system for monitoring the entire traffic area and at least one local system for monitoring at least one partial traffic area of the traffic area. The global system has at least one global communication unit for establishing a global communication connection to an object located in the traffic area. Control commands can be transmitted to the object via the global communication connection. The local system has at least one local communication unit for establishing a local communication connection to the object in the partial traffic area. The following features are implemented: the object is a vehicle which is controlled with the global system in the traffic area, wherein control comprises determining a route by means of the global system and transmitting control commands via the global communication connection, and the partial traffic area is monitored by the local system and a control command is transmitted to the vehicle by the local communication unit if the vehicle is in the partial traffic area and the local system detects a hazardous situation.

A traffic monitoring system may be understood as meaning a system that controls an object from a starting point to a destination, for example a vehicle from a transfer region to a free parking area. The vehicle is controlled by means of control commands which are generated by the traffic monitoring system on the basis of sensors in the traffic area and are transmitted by the traffic monitoring system to the vehicle. The vehicle is monitored by the traffic monitoring system, wherein the control commands can be adapted on the basis of the environment, for example if a pedestrian enters the vehicle's path. In this case, the traffic monitoring system is divided into a global system and at least one local system.

In this context, a global system may be understood as meaning a system that includes the entire traffic area and a global communication unit. In addition, the global system may be superordinate to the local system in the system hierarchy. For example, the global system and the local system cannot establish a communication connection to each other. Alternatively, the global system can receive data from the local system and the local system can receive data from the global system.

The global communication unit may be used for communication between the global system and the object and establishes a global communication connection between the global system and the object. The global communication unit can be used to transmit control commands from the global system to the object. In addition to transmitting control commands to the object, data can also be transmitted from the object to the global system via the communication connection. These data may include, for example, vehicle data, such as speed and/or steering angle and/or environmental information.

In this context, a local system may be understood as meaning a system that includes a local communication unit and a partial traffic area, i.e. a defined region of the entire traffic area. The local system may be subordinate to the global system in the system hierarchy. Alternatively, the global system and the local system can be equal on the hierarchy level.

The local communication unit is used for local communication between the local system and the object located in the partial traffic area of the local system and establishes a local communication connection between the local system and the object. The local communication unit can be used to transmit control commands from the local system to the object. Alternatively, in addition to control commands, data can be transmitted from the object to the local system. These data may include, for example, vehicle data, such as speed and/or steering angle and/or environmental information. The local communication unit can establish an undirected local communication connection, i.e. it establishes a local communication connection to all vehicles in its partial traffic area. Alternatively, the local communication unit establishes a directed local communication connection, i.e. it establishes a local communication connection to a specific vehicle in its partial traffic area. The local communication unit may be for example a unit for emitting electromagnetic waves, in particular radio waves of any kind, e.g. ultrashort waves.

The global communication connection between the global communication unit and the object may be checked by the local communication unit. Thus, the local communication unit can transmit a control command to the object immediately after an interruption in the global communication connection, which command, for example, brings the object to a standstill. Alternatively, the control command from the local communication unit can be transmitted after a defined time. In addition, the global communication system can check the global communication connection and, in the event of the global communication connection between the global communication unit and the object being terminated, can transmit the loss of the communication connection to the local communication unit. This means that the control command is only transmitted to the vehicle in which the communication connection has been terminated and could get into a critical situation.

A control command is an instruction to transfer a vehicle or multiple vehicles within the partial traffic area to a safe state in which dangerous situations are avoided. The safe state is achieved when the vehicle could be parked at its previously defined target position or when the vehicle is brought to a standstill, for example at a location that is not required as a path for other vehicles.

The control command from the local communication unit may be an emergency stop. In this case, braking devices of the object are controlled immediately after receiving the control command in such a way that the object comes to a standstill essentially immediately. This allows the object to be brought to a standstill immediately if the global communication connection is terminated, thus making it possible to reduce the risk of a potential accident. The emergency stop applies to all objects in the relevant partial traffic area. Alternatively, the emergency stop applies only to the object that has lost the global communication connection. This allows the relevant partial traffic area of the traffic monitoring system to be stopped, but allows all other partial regions to continue to be used by vehicles.

Furthermore, the control command from the local communication unit can take precedence over the control command from the global communication unit. If, for example, the local communication unit captures information about the partial traffic area that could lead to a hazardous situation and that has not been received by the global communication unit, for example due to a faulty connection to a sensor, the local communication unit can transmit a control command to the object in order to prevent the occurrence of the hazardous situation.

This can be achieved by comparing the local communication unit with the data from the global communication unit that are transmitted to the object. In particular, the data from two local communication units are compared, wherein, if a fault in the global communication connection is detected by both local communication units, a control command is transmitted to the object by at least one local communication unit.

The global communication unit may disable the precedence of the control command from the local communication unit. This can be achieved by transmitting a corresponding command to the local communication unit. Alternatively, a control command can be transmitted from the global communication unit to the object. This control command requires the object to treat control commands from the corresponding local communication unit with subordination or to ignore them completely. Thus, the global communication unit can prevent local communication units, which, for example, perform erroneous calculations, from establishing a local communication connection and/or can cause the object to ignore the control command from the local communication unit.

The local communication unit may transmit information about the control command transmitted to the object to the global communication unit. This allows the global communication unit to check and/or store the control commands from the local communication unit. In the event of an erroneous control command, the global communication unit can transmit a new control command to the object. The control of the object is adapted to the control command when the communication connection is resumed.

Furthermore, the traffic monitoring system may comprise at least two sensors, wherein the at least two sensors can detect the object located in the partial traffic area and/or traffic area. When the at least two sensors detect the object, they can transmit information, such as speed, steering angle, position and/or identification feature of the object, to the local communication unit and/or the global communication unit. The sensors can be cameras, radar, lidar and/or ultrasonic sensors, for example.

The traffic monitoring system can preferably check the establishment of a local communication connection between the local communication unit and the at least one object. This can be achieved, for example, by querying the local communication unit in order to determine whether a local communication connection could be established between the local communication unit and the object. In addition, the global communication unit can query the object in order to determine whether a local communication connection to a local communication unit could be established. Thus, a faulty local connection or a local connection that has not been established can be detected and measures, such as reducing the speed of the object, can be taken if necessary.

In addition, the traffic monitoring system can cyclically check the local communication connection between the local communication unit and the at least one object. This means that faulty local communication connections can be detected and measures, such as reconnecting the local communication unit or transmitting information to the traffic monitoring system, can be taken if necessary.

The traffic monitoring system may be divided into at least two partial traffic areas, wherein the at least two partial traffic areas are separated from each other with respect to the local communication connections to the at least one object. This can prevent the object from receiving control commands from multiple local communication units. Thus, no further stipulation of the order of precedence of control commands from multiple local communication units

In addition, the traffic monitoring system may be divided into at least two partial traffic areas, wherein the at least two partial traffic areas form an overlapping region with respect to the local communication connections to the at least one object. Overlapping of the two partial traffic areas means that a transfer from one local communication unit to the next communication unit can be implemented without interruption. Thus, there is always a global communication connection and a local communication connection to the object, thus avoiding a region in which there is no local communication connection.

At least two local communication connections may be established to the object located in the overlapping region of at least two partial traffic areas, wherein the at least one object implements/accepts only the control command from the local communication connection with the greatest signal strength. This ensures that the object accepts and implements only one control command from a local communication unit.

Any transmission of data and/or control commands from the global communication unit, the local communication unit and/or the sensors may be wired or wireless. Wired communication can take place by means of appropriate cables or cable harnesses, for example a bus or Ethernet, and wireless communication can take place, for example, by means of mobile radio, ultra-wideband (UWB) or WLAN. The wireless communication connection may work with adapted transmission strengths and/or directional antennas.

A control unit that performs calculations and/or checks, such as a collision calculation, can be assigned to the global communication unit and to each local communication unit. Alternatively, there is a control unit connected to the global communication unit and the local communication units.

### BRIEF DESCRIPTION OF THE DRAWINGS

Further details will become apparent from the following description in conjunction with the accompanying drawings, in which:

FIG. 1 shows a schematic illustration of the traffic monitoring system with division into a traffic area and a partial traffic area;

FIG. 2 shows a schematic illustration according to FIG. 1 with two separate partial traffic areas;

FIG. 3 shows a schematic illustration according to FIG. 2 with overlapping partial traffic areas.

### DETAILED DESCRIPTION

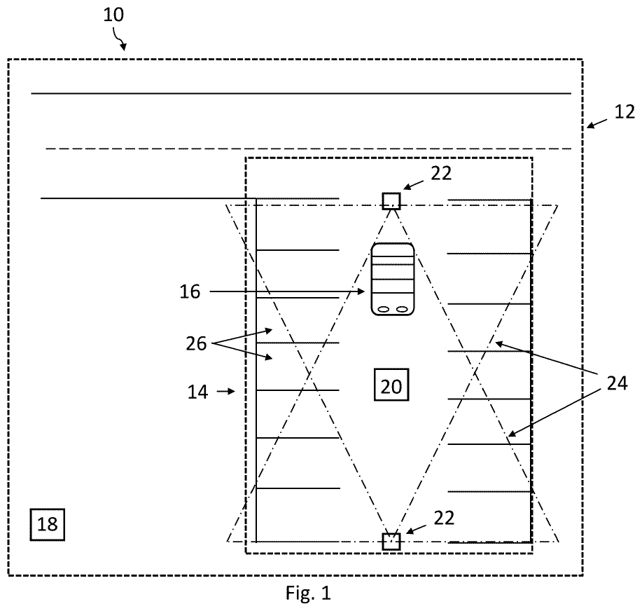

FIG. 1 shows a traffic monitoring system 10 for a traffic area 12. The traffic monitoring system 10 comprises a global system and at least one local system. The global system comprises a global communication unit 18 for the entire traffic area 12. The local system comprises a local communication unit 20 and a partial traffic area 14. At least one object 16, also referred to as a vehicle below, is located in the traffic area 12.

The global communication unit 18 establishes a global communication connection to the vehicle 16. The global communication unit 18 can transmit control commands to the vehicle 16 by means of this global communication connection.

The local communication unit 20 of the partial traffic area 14 establishes a local communication connection to the vehicle 16 when the vehicle is located in the partial traffic area 14. The local communication unit 20 can transmit control commands to the vehicle 16 by means of the local communication connection. The global communication connection and the local communication connection exist simultaneously to the vehicle 16.

The traffic monitoring system 10 also has sensors 22 which generate information about the vehicle 16. This information may be the position and/or speed and/or steering angle and/or safety status and/or vehicle information, such as light on or off. Based on this information, the traffic monitoring system 10 can use a control unit not shown here to carry out calculations which, for example, identify a collision or define a distance. A sensor 22 has a monitoring region 24 in which the sensor 22 can uniquely identify the vehicle 16. In this exemplary embodiment, the sensors 22 are located only in the partial traffic area 14. However, the sensors 22 may also be included in the traffic area 12 and monitor the entire traffic area 12.

A starting point, which is not shown and is also referred to as a transfer region, for the vehicle 16 and a destination 26, also referred to as a parking space 26, are also included in the traffic monitoring system 10. For reasons of clarity, only two parking spaces 26 are provided with reference signs.

At the beginning, the vehicle 16 is parked by a driver or the occupants in the transfer region not shown and transferred to the traffic monitoring system 10. The traffic monitoring system 10 first establishes a global communication connection to the vehicle 16 by means of the global communication unit 18. The traffic monitoring system 10 selects a suitable destination 26 for the vehicle 16. This destination 26 can be determined by the traffic monitoring system 10 by means of sensors, not shown, at the destination 26 or by means of the sensors 22. For this purpose, the control unit can carry out the necessary calculations and generate control commands for the vehicle 16. The control commands are transmitted to the vehicle 16 by means of the global communication unit 18, wherein, after receiving the control commands, the vehicle moves from the transfer region to the parking space 26 specified by the traffic monitoring system 10.

In the exemplary embodiment, the vehicle 16 moves in the vicinity of the parking spaces 26 into the partial traffic area 14 of the traffic monitoring system 10. Alternatively, the vehicle 16 may also be located in a partial traffic area 14 from the transfer point. The local system of the partial traffic area 14 establishes a local communication connection to the vehicle 16 by means of the assigned local communication unit 20 as soon as the vehicle 16 is located in the partial traffic area 14. The detection of whether the vehicle 16 is located in the partial traffic area 14 is achieved by means of sensors or information from the global system. The local communication connection exists in addition to the global communication connection.

The traffic monitoring system 10 checks, e.g. cyclically, whether the global communication connection from the global communication unit 18 to the vehicle 16 is present. If the traffic monitoring system 10 detects that the global communication connection is no longer present, the local system with the local communication unit 20 and the local communication connection transmits a control command to the vehicle 16. This control command comprises, for example, an emergency stop, which is transmitted to all vehicles 16 present in the partial region 14. Transmitting the emergency stop as a control command is intended to reduce the risk of a collision between the vehicles 16 and other vehicles, pedestrians or objects.

In order to prevent, if necessary, a blockage of the traffic area 12, the traffic monitoring system 10 can cancel the control command from the local communication unit 20 by means of the global communication unit 18. As a result, the vehicle 16 can move again in the partial region 14. However, this may be carried out at a reduced speed. If the control command is a reduction of the speed of the vehicles 16 in the partial region 14, the sensors 22 can additionally transmit information to the traffic monitoring system. This information enables safe movement of the vehicles 16 at reduced speed. Environmental information from the vehicle 16, which is determined via sensors inside the vehicle, such as ultrasonic sensors or cameras, can also be used for moving the vehicle 16 at reduced speed. The sensors usually cover a defined monitoring region 24.

If another object, for example a pedestrian, is now moving in that partial region 14 of the traffic monitoring system 10 in which the vehicle 16 is also located, this is detected by the traffic monitoring system 10. If the global communication connection from the global communication unit 18 to the vehicle 16 now collapses and the traffic monitoring system 10 detects the loss of the global communication connection, an emergency stop for this partial region is initiated via the local communication connection immediately after detection. This is because moving at reduced speed in the partial region in which the pedestrian is located would not be desirable due to the risk.

If a critical situation is detected in the partial region 14 via the sensors 22, for example because the vehicle 16 and a pedestrian are dangerously close, the local communication unit 20 independently transmits an emergency stop as a control command.

Likewise, the local communication unit 20 triggers an emergency stop when the vehicle 16 is moved into a partial region 14 of the traffic monitoring system, which, however, has been identified at least temporarily as a restricted region, for example due to maintenance work. In order to avoid a potential collision, an emergency stop is transmitted to the vehicle 16 as a control command.

As soon as the local communication unit 20 transmits an emergency stop or a control command to the vehicle 16, this is also transmitted to the traffic monitoring system 10. These data may include, for example, the relevant partial region 14, the relevant vehicle 16 and the reason for the control command.

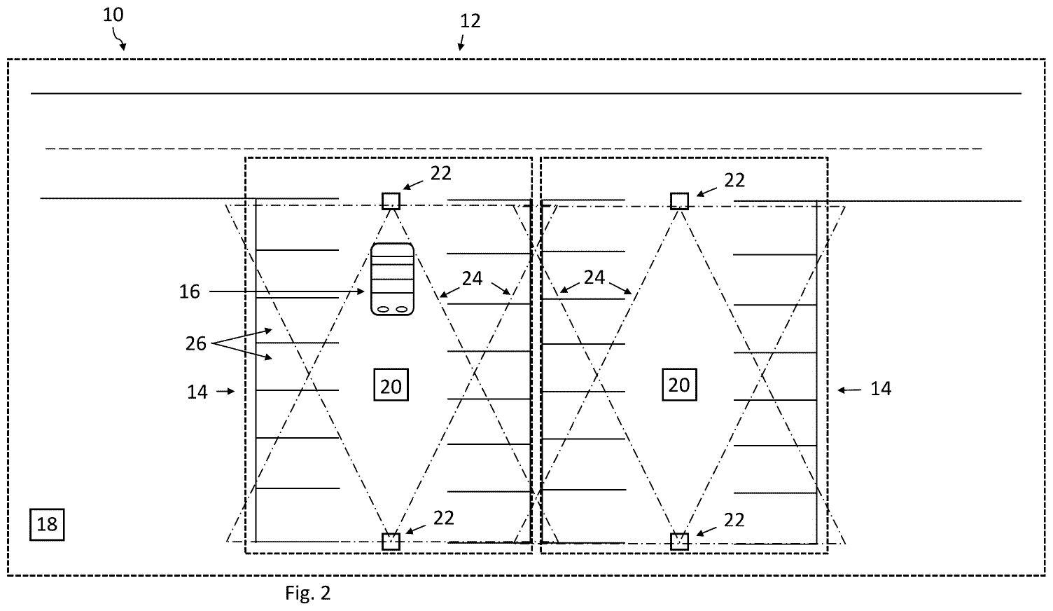

FIG. 2 shows a second exemplary embodiment, wherein the traffic monitoring system 10 has two areas with a multiplicity of parking spaces 26. Each area with parking spaces 26 forms a local system and thus comprises a partial traffic area 14. These two partial traffic areas 14 are separated from each other in terms of signaling, as a result of which the vehicle 16 establishes only a local communication connection to the local communication unit 20 of the corresponding partial traffic area 14 in which it is currently located. If a local emergency stop is now initiated in a partial traffic area 14, the other partial traffic area 14 still remains active. The vehicles 16 in the active partial traffic area 14 may be moved on to the parking spaces 26 of the active partial traffic area 14, independently of the partial traffic area 14 with a local emergency stop. The statements made above also apply to this exemplary embodiment.

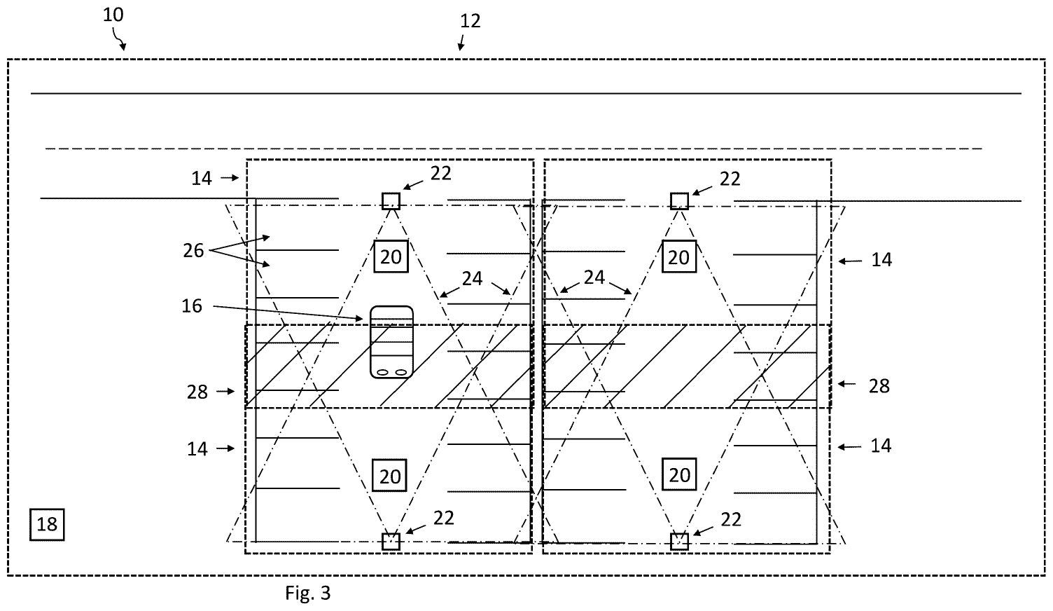

FIG. 3 shows a further exemplary embodiment. Here, the traffic monitoring system 10 again has two areas with a multiplicity of parking spaces 26. However, in this exemplary embodiment, each area has two partial traffic areas 14. These two partial traffic areas 14 are not separated from each other in terms of signaling, thus producing an overlapping region 28, in this case the hatched region. Thus, the vehicle 16 establishes a local communication connection to each local communication unit 20 of the two partial traffic areas 14 in which the vehicle 16 is currently located. Thus, the vehicle 16 has two local communication connections. To prevent an order of precedence of the control commands from the two local communication units when transmitting control commands at the same time, only the control command with the highest signal strength is accepted by the vehicle.

1. A method for monitoring a traffic area with a traffic monitoring system comprising:
monitoring a traffic area with a global monitoring system wherein the entire traffic area is monitored with the global monitoring system;
monitoring at least one partial traffic area of the traffic area with a local monitoring system;
establishing a global communication connection to a vehicle located in the traffic area with at least one global communication unit;
transmitting control commands to the vehicle via the global communication connection;
establishing a local communication connection to the vehicle in the partial traffic area with at least one local communication unit;
controlling the vehicle with the global system in the traffic area, wherein control comprises;
determining a route with the global system; and
transmitting control commands via the global communication connection to the vehicle; and
transmitting a control command to the vehicle by the local communication unit when the vehicle is in the partial traffic area and the local system detects a hazardous situation.

2. The method as claimed in claim 1, wherein the control command from the local communication unit is an emergency stop.

3. The method as claimed in claim 1, wherein the control command from the local communication unit takes precedence over the control command from the global communication unit.

4. The method as claimed in claim 1, further comprising disabling the precedence of the control command from the local communication unit with the global communication unit.

5. The method as claimed in claim 1, further comprising transmitting information, with the local communication unit to the global communication unit, about the control command transmitted to the vehicle.

6. The method as claimed in claim 1, wherein the traffic monitoring system comprises at least two sensors, wherein the at least two sensors can detect the vehicle located in at least one of the partial traffic area and the traffic area.

7. The method as claimed in claim 1, further comprising checking establishment of a local communication connection between the local communication unit and the vehicle with the traffic monitoring system.

8. The method as claimed in claim 7, further comprising cyclically checking the local communication connection between the local communication unit and the vehicle.

9. The method as claimed in claim 1, wherein the traffic monitoring system is divided into at least two partial traffic areas, wherein the at least two partial traffic areas are separated from each other with respect to the local communication connections to the vehicle.

10. The method as claimed in claim 1, wherein the traffic monitoring system is divided into at least two partial traffic areas, wherein the at least two partial traffic areas form an overlapping region with respect to the local communication connections to the at least one object.

11. The method as claimed in claim 10, further comprising establishing at least two local communication connections to the vehicle located in the overlapping region of at least two partial traffic areas, wherein the vehicle implements only the control command from the local communication connection of the at least two local communication connections with a greatest signal strength.
